(19) United States
(12) Patent Application Publication
(10) Pub. No.: US 2013/0099159 A1
(43) Pub. Date: Apr. 25, 2013

(54) PRODUCTION OF METAL OR METALLOID NANOPARTICLES

(71) Applicants: Ion C. Halalay, Grosse Pointe Park, MI (US); Michael P. Balogh, Novi, MI (US)

(72) Inventors: Ion C. Halalay, Grosse Pointe Park, MI (US); Michael P. Balogh, Novi, MI (US)

(73) Assignee: GM GLOBAL TECHNOLOGY OPERATIONS LLC, DETROIT, MI (US)

(21) Appl. No.: 13/280,783

(22) Filed: Oct. 25, 2011

(51) Int. Cl. H01M 4/40; B32B 15/02; C01B 33/021; C01B 33/02; B22F 9/16; H01M 4/583; B82Y 30/00

(52) U.S. Cl. 252/182.1; 75/370; 420/591; 423/350; 423/348; 977/773; 977/948

(57) ABSTRACT

One embodiment may include a method of making nanoparticles comprising elemental metals or metalloids and/or alloys thereof. The method may include reducing a metal halide or a metalloid halide with an alkali metal to produce a reaction product comprising particles of the desired metal or metalloid and a halide salt. One embodiment may include introducing reactants to each other in the presence of a non-reactive solvent and/or inducing cavitation in the reactants and/or the non-reactive solvent when present. Certain metals or metalloids such as tin, aluminum, silicon, antimony, indium or bismuth may be useful in electrochemical cells such as lithium-ion cells when produced by these illustrative methods. One embodiment of a battery electrode may include nanoparticles that may be produced by these or other methods.

### TECHNICAL FIELD

The technical field relates generally to the production of nanoparticles.

### BACKGROUND

Lithium-ion batteries have become popular as rechargeable electrical energy sources for use with a variety of products and devices, such as laptop computers, mobile telephones, and other portable electronics, due to their relatively high voltage or potential per cell, relatively high energy density, ability to maintain a charge while dormant for longer periods of time than other rechargeable batteries, and a reduced presence of the “memory” phenomenon that other types of rechargeable batteries may exhibit when subjected to multiple shallow-discharge and recharge cycles. For many of the same reasons, lithium-ion batteries have been one choice of battery type for use with electric or hybrid vehicles. The types of materials used to fabricate electrodes in lithium-ion and other types of batteries can affect many of their performance characteristics.

### SUMMARY OF SELECT ILLUSTRATIVE EMBODIMENTS

One embodiment includes a method including providing a solution comprising an elemental alkali metal and an aprotic solvent and agitating the solution while adding a halide to the solution. The halide may react with the alkali metal to form a halide salt and particles of a metal or metalloid. The halide may comprise the metal or metalloid, and the metal or metalloid comprises at least one of Sn, In, Al, Sb, Bi or Si.

Another embodiment includes a method including providing a heterogeneous solution comprising a liquefied elemental alkali metal and a liquid solvent; inducing cavitation in the solution; and adding a fluid comprising a halide of a metal or metalloid to the solution while continuing to induce cavitation.

Another embodiment includes a product including an electrochemical cell having a negative electrode. The negative electrode may comprise nanoparticles that comprise an elemental metal or metalloid comprising at least one of Sn, In, Al, Sb, Bi or Si, and the electrode may be substantially free of oxides.

### BRIEF DESCRIPTION OF THE DRAWINGS

Illustrative embodiments of the invention will become more fully understood from the detailed description and the accompanying drawings, wherein:

FIG. 1 is a schematic representation of a battery having a plurality of electrochemical cells;

FIG. 2 is an enlarged view of an electrochemical cell from FIG. 1;

FIG. 3 is a graph showing theoretical specific charges for carbon and various other materials;

FIG. 4 is a graph showing theoretical charge densities for carbon and various other materials;

FIG. 5 is a graph showing charging curves for carbon and various metals;

FIG. 6 is a schematic representation of an apparatus that may be used to produce nanoparticles; and

FIG. 7 is a photomicrograph of metal nanoparticles and microparticles in a halide salt matrix.

### DETAILED DESCRIPTION OF ILLUSTRATIVE EMBODIMENTS

The following description is merely illustrative in nature and is in no way intended to limit the claimed invention(s), its application, or its uses.

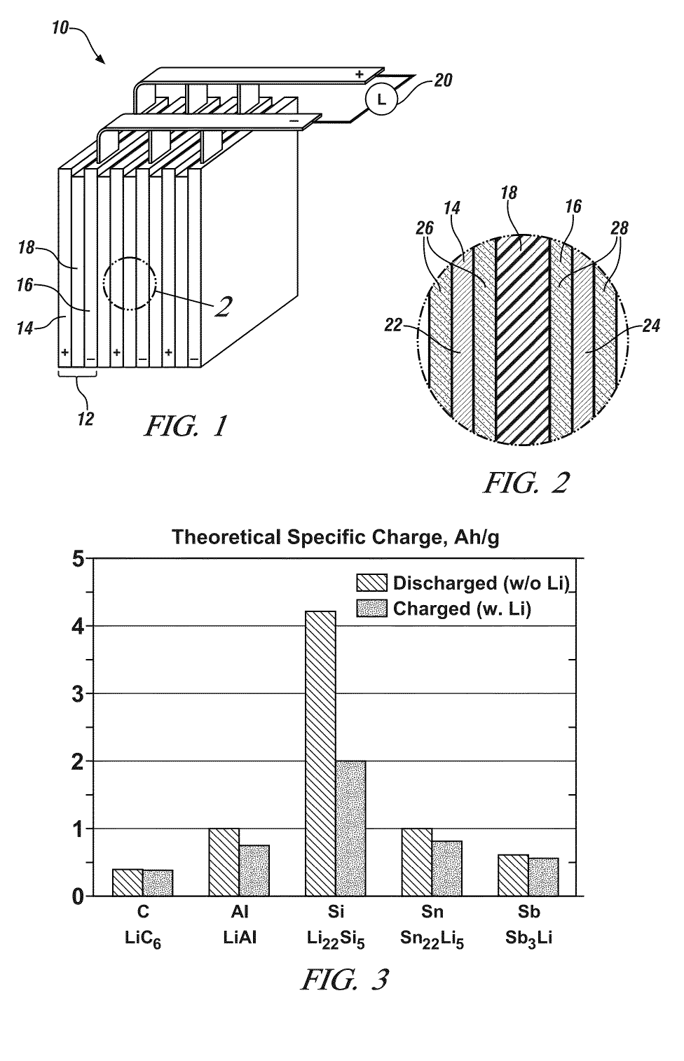

FIG. 1 illustrates one embodiment of a battery 10 comprising a plurality of electrochemical cells 12. Each electrochemical cell may include a positive electrode 14, a negative electrode 16, and an electrolyte 18 disposed therebetween. Multiple cells 12 may be connected in series and/or parallel to provide the desired voltage and current capacity for the battery 10. When connected to an electrical load 20, battery 10 and each of its corresponding electrochemical cells 12 may be placed into a state of discharge. During discharge, electrons flow from the negative electrode 16 of an individual cell, through the load 20, and continue to the positive electrode 14 of the cell. Corresponding positive ions flow from the negative electrode 16, through the electrolyte 18, and continue to the positive electrode 14. The discharge process eventually depletes the negative electrode 16 of its available ion-forming constituents. In electrochemical cells utilizing materials having reversible electrochemical reactions, an applied voltage in place of load 20 may be used, with electron flow in the opposite direction, to cause positive ions to flow from the positive electrode 14, through the electrolyte 18, and back to negative electrode 16 to recharge each cell 12 and the battery 10.

Some examples of rechargeable (or secondary) electrochemical cells include nickel-cadmium (NiCd), nickel-metal hydride (NiMH), lithium-ion (Li-ion), and lead-acid cells, to name a few. Some examples of non-rechargeable (or primary) electrochemical cells include lithium (Li), zinc carbon, and alkaline zinc-manganese oxide (Zn—MnO₂) cells, among others, though some Zn—MnO₂ cells may be rechargeable. Skilled artisans will appreciate that the methods presented herein may be used to produce particulate metals for use in any type of battery or even outside the battery art and that the illustrative battery descriptions below are non-limiting.

Where a battery such as battery 10 of FIG. 1 comprises a plurality of Li-ion cells 12, the electrodes 14, 16 comprise intercalation materials including various amounts of lithium—i.e., lithium atoms are inserted within a layered or tunneled structure of a host material at each electrode where the amount of lithium at each electrode depends on the state of charge of the cells. The positive electrode 14 of a Li-ion cell may include a metal oxide host material and the negative electrode 16 may include a graphite host material. During a discharge cycle, lithium atoms at the negative electrode 16 are ionized, with the Li⁺ ions flowing through the electrolyte 18 and the corresponding electrons flowing through electrical load 20, with lithium being reformed at the positive electrode 14 and intercalated with the metal oxide host material. During a charging cycle, the reverse process occurs, with lithium being ionized and migrating from the positive electrode 14 to the negative electrode 16.

FIG. 2 illustrates one example of a lithium-ion cell in further detail. Shown again are the positive and negative electrodes 14, 16 separated by electrolyte 18. The electrolyte 18 in a lithium-ion cell may include a non-aqueous liquid electrolyte including an organic solvent, such as one or more organic carbonates, for example, with suitable dissolved lithium salts. The electrolyte 18 may be absorbed in a thin microporous polymer separator that electrically insulates the electrodes 14, 16 from one another while allowing Li⁺ ions to flow therethrough. Each electrode may be constructed with a current collector coated on its opposite surfaces with an electrode material. For example, positive electrode 14 may include current collector 22 coated with positive electrode material 26. Current collector 22 may be an aluminum or other metallic foil, and positive electrode material 26 may include a metal oxide, such as lithium cobalt oxide (LiCoO₂) or lithium manganese oxide (LiMn₂O₄), for example. Negative electrode 16 may include current collector 24 coated with negative electrode material 28. Current collector 24 may be a copper or other metallic foil, and negative electrode material 28 may include graphitic carbon, sometimes designated LiC₆. Coating each current collector 22, 24 on both sides allows adjacent cells to utilize common current collectors.

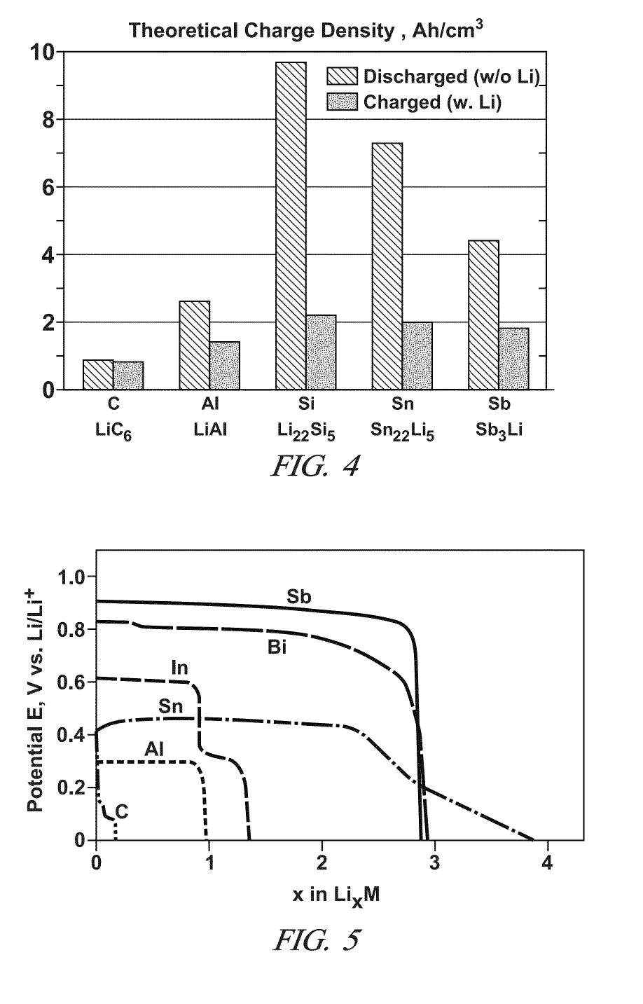

Though graphitic carbon may be a widely used host material for Li-ion negative electrodes, it is not necessarily an ideal material from an electrical performance standpoint. For example, FIG. 3 illustrates the theoretical specific charge, or charge per unit mass, for carbon along with other elemental metals or metalloids when intercalated with lithium. FIG. 4 illustrates the theoretical charge density, or charge per unit volume, for carbon along with other elemental metals or metalloids when intercalated with lithium. As shown, silicon (Si) and some metals such as aluminum (Al) and tin (Sn) may have theoretical specific charges and charge densities that are more than double that of graphite. For example, graphite may provide a theoretical specific charge of about 0.4 Ah/g, while Sn may provide a theoretical specific charge of about 1.0 Ah/g. Also, graphite may provide a theoretical charge density of about 0.8 Ah/cm³, while Sn may provide a theoretical charge density of about 7.0 Ah/cm³. Materials having higher available charge densities and specific charges may be used to fabricate battery electrodes and/or batteries that weigh less, that last longer between required recharges, and/or that are smaller than batteries utilizing graphite as a negative electrode material.

FIG. 5 illustrates charging curves for graphitic carbon along with other elemental metals or metalloids when intercalated with lithium. As shown, about 50% of the Li uptake by graphitic carbon at the negative electrode during a charging cycle occurs at a potential of about 0.085V vs. Li/Li⁺. This can cause some problems during high-rate charging of a battery, particularly at low temperatures. Si and the metals shown in the curves of FIG. 5, besides allowing higher gravimetric and volumetric charges as already noted, may also allow higher potentials during a charging cycle, from about 0.3V to about 0.9V, for example. Additionally, the shapes of some of the charging curves may be beneficial for state-of-charge diagnostics. For example, the double plateau curve illustrated with indium (In) or the constant slope portion of the Sn curve could be used as an indicator of state-of-charge.

Though the metals and metalloids described and characterized in FIGS. 3-5 may provide many of these advantages over graphite as a negative electrode material in a Li-ion battery, these advantages have never been realized by battery manufacturers due to the inability to successfully or effectively produce any of these or other useful elemental metals or metalloids having particle sizes that are small enough to be used as an intercalated material host. One method of producing elemental nanosize metal particles for use as a battery electrode material is to synthesize a nanosize oxide of the metal, fabricate a negative electrode using the oxide, and electrochemically reduce the oxide using lithium metal during the first charging cycle of the battery, where the lithium metal is initially stored in the positive electrode material. This method may include various difficulties, one of which is the fact that lithium metal initially included in the battery is wasted, reducing the overall battery capacity. In other words, some of the lithium initially included with the positive electrode material irreversibly forms lithium oxide (Li₂O) on the negative electrode, which also may detrimentally increase the resistance of the negative electrode material.

Producing elemental metals and/or metalloids and alloys thereof by the methods described herein may help to alleviate some of these disadvantages and allow the use of certain metals or metalloids in Li-ion or other battery electrode materials, alone or in combination with other electrode materials such as graphitic carbon. Battery electrodes may thus be produced substantially free of oxides. As used herein, the term “nano,” used alone or as a prefix to describe size, refers to dimensions of less than 1 μm, and the term “micro,” used similarly, refers to dimensions from 1 μm up to 1 mm. One embodiment may include battery electrode material including nanoparticles including 50-90 weight percent, greater than 90 weight percent, or substantially all of the nanoparticles having dimensions (e.g. width or diameter) less than one micron.

The methods disclosed below for producing metal or metalloid particles on a micro or nano scale generally include reducing a halide of the desired metal or metalloid with an alkali metal, represented generally by equation (1), below:

MHₓ+xA→xAH+M (1),

where M is the desired metal or metalloid, H is a halogen, and A is an alkali metal. The reaction products may include an alkali-metal halide (or a halide salt), AH, and the desired metal or metalloid M. In one embodiment, the reaction occurs in the presence of a solvent or reaction medium that is non-reactive with the reactants or reaction products. For example, the solvent may be aprotic so that the alkali metal does not release hydrogen atoms from the solvent. The solvent may be liquid and may remain substantially in its liquid phase at the solution temperatures during the reaction. Illustrative solvents may be non-polar and/or organic, and may particularly include organic solvents comprising hydrocarbons. One example of a suitable saturated hydrocarbon solvent that may be used as a reaction medium is mineral oil. Any other hydrocarbon-based oil may be suitable as well, along with other types of non-reactive oils such as silicon-based oils.

The reaction according to equation (1) may also occur in the presence of agitation. The agitation may include high-speed or high-shear mixing, such as mixing with an impeller or other fluid displacement device that can provide turbulent mixing; ultrasonic mixing, such as exposure to low intensity ultrasonic waves; or other type of agitation. The agitation may be included to help expose as much surface area of the alkali metal as possible to the halide of the desired metal or metalloid (MHₓ). The agitation may also be of an intensity or may induce a sufficiently high Reynolds number that it produces cavitation in the reaction constituents and/or in the reaction medium such as one or more of the above-described hydrocarbon solvents. Cavitation is a phenomenon that may occur in a liquid wherein gas bubbles are formed in the liquid at localized low pressure sites within the liquid. Cavitation may be initiated when the local pressure at such sites falls below the vapor pressure of the liquid, thus locally vaporizing the liquid to form the gas bubbles. Such localized low pressure sites may exist at or near the surface of a high-speed impeller or a component vibrating at ultrasonic frequencies, for example. After formation, localized fluid conditions (i.e., temperature, pressure, and/or temperature) at or near a gas bubble may again change, causing the gas bubble to collapse. For example, a gas bubble formed at the surface of a high-speed impeller may be carried in the fluid flow field to a lower velocity (higher pressure) region of the flow field and collapse or implode, with the gaseous constituent(s) returning to the liquid phase. Depending on the cavitation conditions, the gas bubbles may include one or more reactants and/or reaction medium when formed and may include reaction product prior to collapsing. Thus, cavitation may be useful to disperse reactants within the reaction medium and/or to provide high energy (gas-to-gas) reaction sites for the reactants in a liquid medium.

The alkali metal, the MHₓ, or both of the reactants of equation (1) may be in one of their respective fluid phases (liquid or vapor) prior to and/or during the reaction. For example, the alkali metal may be heated to its solid-to-liquid phase change temperature or above so that it is at least partially liquid before being exposed to the MHₓ. Likewise the MHₓ may be a liquid, vapor, or a mixture of liquid and vapor when introduced to the reaction and/or during the reaction. In one embodiment, each of the reactants and the reaction medium are in their respective liquid phases at the beginning of the reaction. However, this is not always necessary, such as in instances in which one or more of the reactants, such as the MHₓ, may be in its solid phase in powder or particulate form on a micro or nano scale or in its vapor phase, for example. In another embodiment, the MHₓ may be provided in liquid form as part of a solution. For example, it may be dissolved in a suitable non-reactive solvent that is miscible with the reaction medium so that it may be introduced to the reaction in liquid form at a temperature that is below its melting point. The alkali metal and the MHₓ may be provided in stoichiometrically balanced amounts so that there is substantially no unreduced MHₓ or alkali metal remaining at the completion of the reaction.

In another embodiment, more than one alkali metal may be included in the reaction according to equation (2), below:

MH_{x+y}+xA+yB→xAH+yBH+M (2),

where M is the desired metal or metalloid, H is a halogen, A is a first alkali metal, and B is a second alkali metal. The reaction products in this example may include two halide salts, AH and BH, and the desired metal or metalloid M. More than two different alkali metals may be used as well to form particulate metal or metalloid particles with discrete elemental compositions, particles of an alloy comprising two different metals or metalloids, or both.

In another embodiment, an excess of the alkali metal may be provided as a reactant according to equation (3), below:

MHₓ+(x+y)A→xAH+yA+M (3),

In this example, the excess alkali metal may form an alloy with metal or metalloid M. In one embodiment, the reaction temperatures may be at or above the respective melting points of A or M or both of A and M. The composition of such an A-M alloy may be controlled by controlling y, which represents the amount of alkali metal that is present and in excess of the amount necessary to reduce all of the reactant halide or halides.

The reaction conditions may be controlled so that it occurs in an inert environment to reduce or eliminate any oxidation of reactants or reaction products and to help prevent the alkali metal from reacting with atmospheric water, for example. As already described, the non-reactive reaction medium or solvent partially facilitates the inert environment. In addition, the reaction may occur in a reaction vessel, where the space not occupied by the reactants is filled with an inert gas such as argon or with another gas that is non-reactive with respect to the reactants or reaction product. The reaction vessel may be temperature and/or pressure controlled as well. For example, the vessel may include provisions for heating, which may be used to bring the alkali metal into its liquid phase, for example. It also may include provisions for cooling to further control the reaction temperatures. Pressure control may be provided to maintain some constituents having high vapor pressures at the reaction temperatures in their liquid phase for better mixing and reacting with liquefied alkali metal, for example.

Some examples of metals and metalloids that may be produced by the methods described herein include aluminum (Al), tin (Sn), indium (In), bismuth (Bi), antimony (Sb), or silicon (Si), though other metals or metalloids may be produced from respective halide compounds thereof. The reactant halides (MHₓ or MH_{x+y} in equations 1-3) may include compounds of any of these or other illustrative metals or metalloids that include a halogen selected from group VIIA of the periodic table. Some chlorides of the illustrative metals or metalloids listed above may be suitable, for example. Where more than one chloride or other halide compound can be formed with a given metal or metalloid (such as stannic chloride and stannous chloride with Sn, for example), the preferred halide may be one in fluid form at the reaction temperatures. Alkali metals may be selected from group IA of the periodic table, excluding hydrogen.

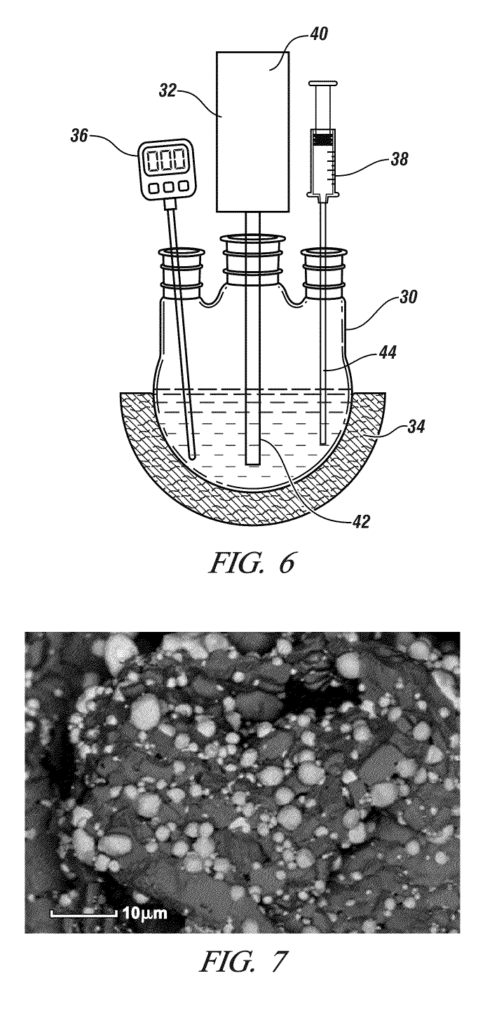

With reference to FIG. 6, an illustrative reaction set-up may be described, including a reaction vessel 30, an agitator 32, and a temperature controller 34. In the experimental set-up shown, reaction vessel 30 is a three-neck round-bottom flask, where the three necks accommodate the agitator 32, a thermometer 36, and a reactant container 38, which is a syringe in this example. Agitator 32 may include a high-speed or high-shear mixer, an ultrasonic mixing device, or other type of agitator, and includes an actuator 40 and a working end 42. Where agitator 32 is a high-shear mixer, actuator 40 may include an electric motor that drives working end 42, which may include an impeller, for example. Where agitator 32 is an ultrasonic mixer, actuator 40 may include an ultrasonic transducer that vibrates working end 42 at a desired frequency. Thermometer 36 may be provided to monitor the reaction temperature, and reactant container 38 may be provided to transfer reactant to the reaction vessel 30 from a separate location. In the example shown, syringe 38 can transfer reactant, such as a metal or metalloid halide, into reaction vessel 30 via conduit 44. Temperature controller 34 may be a contoured electric heating element as shown, or it may be any other type of heating and/or cooling element such as a water or oil bath, for example. Of course, the reaction set-up illustrated is only illustrative in nature and may take many forms, including scaled-up forms for larger scale production of particulate metals or metalloids.

### Example

One example of making particular elemental metals on a nano or micro scale may be described with reference to FIG. 6. In particular, elemental Sn particles may be produced according to equation (4) below (derived from equation 1):

SnCl₄+4Na→4NaCl+Sn (4).

In this example, a 1000 ml round-bottom-flask 30 was partially filled with 200 ml of mineral oil as a solvent. 5.64 g (0.245 moles) of elemental sodium metal (Na) was added to the solvent. Each of the high-shear mixer 32, thermometer 36, and 10 ml syringe 38 were inserted into their respective flask neck openings, which were then tightly sealed after flooding the space above the solvent with argon gas. Heating element 34 was used to increase the temperature of the Na-oil mixture to 100° C., or about 2° C. above the melting point of Na. After the Na was liquefied, the shear mixer 32 was powered on to mix the Na and the mineral oil, producing a finely dispersed heterogeneous solution of the Na in the mineral oil, which may also be described as a colloidal suspension. While mixing, a stoichiometrically balanced amount (7.2 ml, 16.0 g, 0.0615 moles) of stannic chloride (SnCl₄) was slowly added to the Na-oil solution from syringe 38, changing the color of the solution from grey to black. Mixing continued for an additional 10 minutes after the addition of the SnCl₄. The flask 30 was then cooled to room temperature. The mineral oil was removed from the reaction products by washing it in the flask three times using pentane. After drying the pentane from the reaction products, it was removed from the flask and washed with water to dissolve and remove the NaCl. After drying the water from the remaining reaction product, elemental Sn powder was obtained.

FIG. 7 shows an SEM photomicrograph of the Sn and NaCl reaction product produced by the above-described experiment using the apparatus of FIG. 6 after the pentane wash. 20.976 g of reaction product was produced from the 21.64 g of reactants for a 97% yield. In FIG. 7, the light, rounded particles are Sn, and the dark, faceted areas are NaCl crystals. The Sn particles generally range in size from about 100 nm to about 2 nm in width or diameter, though, as can be seen from FIG. 7, there are some finer Sn particles that appear to be as small as about 20 nm or less in width and a small number of particles that appear to be as large as about 3 nm in width. X-ray diffraction (XRD) data verified the composition of the reaction product as Sn metal and NaCl with trace amounts of tin oxide (SnO) that are likely surface oxides on the Sn particles from exposure to the atmosphere. Additional XRD data was collected after washing the reaction product with water to remove the NaCl and showed that all of the NaCl was removed, with only Sn metal and trace amounts of SnO remaining After the water wash, the Sn metal was weighed and determined to be 33.1 wt % of the reaction product, matching well with the expected 33.7 wt % as calculated from equation (4).

It is noted that some of the method steps outlined above may vary depending on the reactants used and the reaction products produced. For example the temperature of the reactants may change based on the melting point of the alkali metal or metals and/or other factors. Also, solvents other than pentane may be used to wash the reaction medium from the reaction product, such as other volatile organic solvents. Volatile organic solvents may be useful with oil-based reaction media because they dissolve the oil, do not dissolve the reaction products, and evaporate quickly after use. Other solvents having similar characteristics may also be useful. Additionally, polar solvents other than water may be used to remove the halide salt from the reaction product. It may be preferred to remove the halide salt from the reaction product using an aprotic polar solvent, for example, to minimize the formation of surface oxides on the metal or metalloid particles. Suitable aprotic solvents for washing the reaction product to remove the halide salt may include polar organic solvents such as dimethylformamide (DMF), tetrahydrofuran (THF), or others.

In another specific example, equation (3) above may be followed as in the reaction according to equation (5), below, to form particles of an Sn—Li alloy:

SnCl₄+5Li→4LiCl+Li+Sn (5).

In this illustrative reaction, the alkali metal is lithium, which is provided in an amount in excess of the amount necessary to reduce all of the stannous chloride such that a Sn—Li alloy may be formed as a reaction product with the Li and Sn content being present in the alloy in equal molar quantities. Of course, the lithium may be provided in any excess quantity and does not have to be provided as a whole number molar quantity as shown. The method of making an illustrative lithium alloy as shown may include providing the lithium in an aprotic solvent or reaction medium and increasing the temperature of the Li-solvent mixture to 181° C. or higher to liquefy the lithium prior to the introduction of the SnCl₄. Such alloy particles that include both lithium and metals or metalloids that can provide high charge densities and/or high specific charges when used as battery electrode materials may be particularly useful in Li-ion batteries as electrode materials. Other metals or metalloids and their halide compounds may of course be reacted with Li or other metals to form alloy particles, and the reaction may be tailored with specific alkali metals and halides to form the desired alloy and/or to select reactants and reaction products that may be in fluid phases at comparable temperatures.

The above description of embodiments is merely illustrative in nature and, thus, variations thereof are not to be regarded as a departure from the spirit and scope of the invention.

What is claimed is:

1. A method comprising:
providing a solution comprising an elemental alkali metal and an aprotic solvent;
agitating the solution while adding a halide to the solution that reacts with the alkali metal to form a halide salt and particles of a metal or metalloid;
wherein the halide comprises the metal or metalloid and the metal or metalloid comprises at least one of Sn, In, Al, Sb, Bi or Si.

2. The method set forth in claim 1, wherein agitating the solution comprises inducing cavitation in the solution.

3. The method set forth in claim 1, wherein agitating the solution comprises at least one of high-shear mixing or ultrasonic mixing.

4. The method set forth in claim 1, wherein the solvent comprises a hydrocarbon liquid.

5. The method set forth in claim 1, wherein the halide is in fluid form.

6. The method set forth in claim 1, wherein the elemental alkali metal is sodium.

7. A method comprising:
providing a heterogeneous solution comprising a liquefied elemental alkali metal and a liquid solvent;
inducing cavitation in the solution; and
adding a fluid comprising a halide of a metal or metalloid to the solution while continuing to induce cavitation.

8. The method set forth in claim 7, wherein the solvent comprises a hydrocarbon.

9. The method set forth in claim 7, wherein the metal or metalloid comprises at least one of Sn, In, Al, Sb, Bi or Si.

10. The method set forth in claim 7, wherein the step of inducing cavitation comprises at least one of high-shear mixing or ultrasonic mixing.

11. The method set forth in claim 7, wherein the liquefied alkali metal comprises sodium metal.

12. The method set forth in claim 7, wherein the halide comprises a chloride.

13. The method set forth in claim 7, wherein the halide is added in an amount that is stoichiometrically balanced with the amount of provided alkali metal.

14. The method set forth in claim 7, wherein the halide is added in an amount that is less than the amount required to stoichiometrically balance the halide with the alkali metal.

15. The method set forth in claim 14, wherein the alkali metal comprises lithium.

16. A product comprising:
an electrochemical cell having a negative electrode comprising nanoparticles that comprise an elemental metal or metalloid comprising at least one of Sn, In, Al, Sb, Bi or Si, wherein the electrode is substantially free of oxides.

17. The product of claim 16, wherein the electrochemical cell is a lithium-ion cell.

18. The product of claim 16, wherein the negative electrode comprises an alloy comprising lithium and the elemental metal or metalloid.

19. The product of claim 16, wherein the negative electrode comprises microparticles that comprise the elemental metal or metalloid.

20. The product of claim 16, wherein the negative electrode further comprises carbon.
